(19) United States
(12) Patent Application Publication
(10) Pub. No.: US 2016/0200046 A1
(43) Pub. Date: Jul. 14, 2016

(54) APPARATUS AND METHODS FOR FABRICATING AN OBJECT

(71) Applicant: Xactiv, Inc., Fairport, NY (US)

(72) Inventors: Robert Edward ZEMAN, Webster, NY (US); Peter J. MASON, Fairport, NY (US)

(73) Assignee: Xactiv, Inc., Fairport, NY (US)

(21) Appl. No.: 14/994,178

(22) Filed: Jan. 13, 2016

Related U.S. Application Data
(60) Provisional application No. 62/103,476, filed on Jan. 14, 2015.

(51) Int. Cl. B29C 67/00; B22F 3/10; B29C 65/08; B22F 7/04

(52) U.S. Cl. CPC B29C 67/0077; B22F 7/04; B22F 3/1017; B29C 67/0092; B29C 65/08; B33Y 10/00

(57) ABSTRACT

An apparatus for forming a part, comprising a substrate for holding the part during forming; a transport web; a web delivery system; a powder generation system configured to deposit a portion of powder on a portion of the web delivered by the delivery system; a sintering station configured to sinter the portion of powder on the delivered portion of the transport web; and a transfer station configured to transfer the sintered portion of the powder from the transport web to a partially formed portion of the part and join the sintered portion of the powder to the partially formed part. Additionally, a method for making a part comprising depositing a first portion of a powder on a transport web substrate; sintering the first portion of powder on the web substrate; and joining the sintered portion of the powder to the support substrate to form a first layer of the part.

### CROSS-REFERENCE TO RELATED PATENT APPLICATIONS

This application claims priority to U.S. Provisional Patent Application No. 62/103,476 filed Jan. 14, 2015, the disclosure of which is incorporated herein by reference.

### BACKGROUND

1. Technical Field

Apparatus and methods for fabricating objects or parts by additive manufacturing. More particularly, an apparatus and method for fabricating a part by forming the part in a sequence of layers, each of the layers transferred and joined to the partially formed part in a single step over a large area of the part.

2. Description of Related Art

Recent advances in microelectronics, material compositions, and material processing on a microscale have enabled new object fabrication methods. Such fabrication methods typically involve the creation of a digital or “virtual” three-dimensional model of the object to be fabricated, which is then uploaded to fabrication process equipment that may fabricate the object as a series of two dimensional layers. Such fabrication processes, which include fused deposition modelling, selective laser melting, direct metal laser sintering, and selective laser sintering, are often referred to as additive manufacturing or “3-D printing.”

In the field of 3-D printing, many approaches such as fused deposition modelling, selective laser melting, direct metal laser sintering, and selective laser sintering have been used to create a desired object. However, throughput remains a major drawback of these current approaches. For a part of even modest complexity, many hours are often required to produce the part. One approach to increasing fabrication speed is to adapt a process used in xerography, by which thin layers of powder (similar to a xerographic toner) are generated as the material from which to create the 3-D part. Methods and apparatus for such fabrications are disclosed in the Applicant's commonly owned U.S. Pat. No. 8,771,802, entitled, “Device and Materials Fabrication and Patterning Via Shaped Slot Electrode Control of Direct Electrostatic Powder Deposition,” the disclosure of which is incorporated herein by reference.

Although such methods and apparatus can generate the layers quickly, significant major problems remain in the “build” part of the 3-D process. One problem is the accumulation of residual charge in the layers of powder of the part being fabricated. Using conventional electrostatic transfer of powder to build up a three-dimensional object is not feasible, since the quantity of charge accumulated in the part after a few transfers of layers causes substantial reduction and even complete loss of the transfer field. Attempting to discharge the transferred powder after each layer transfer does not solve the problem, because after multiple transfers of layers, establishing an effective transfer field across a thick plastic part in order to cause discharge also becomes difficult.

Another countermeasure, discharging the powder before transfer to the 3-D part, reduces the options for subsequent layer transfer approaches to few, such as utilizing heat and pressure to fuse the powder particles into a solid layer. Heat may be effectively used; however, heat transfer through a powder layer is a slow process occurring primarily by conduction, and must be carefully managed, particularly when large plastic parts are being fabricated. Heating to fuse the particles becomes the rate-limiting step in this particular approach to 3-D printing, typically requiring several seconds per transfer and thereby negating the increased throughput obtained by using xerographic methods to generate the powder for layer deposition.

In an additive manufacturing process in which a part is fabricated by deposition and fusion of sequential layers of powder, there remains a need for a method of rapidly depositing a sequence of powder layers, and rapidly fusing them into solid layers, so that the overall part is made at a rapid throughput and with the required dimensional accuracy.

### SUMMARY

The present invention meets this need by providing an apparatus for forming a part, comprising a substrate for holding the part during forming; a transport web; a transport web delivery system; a powder imaging system configured to deposit a sequence of imaged layers of powder defining cross sections of the part on a sequence of areas of the transport web delivered by the web delivery system; a sintering station configured to sinter the sequence of imaged layers of powder on the transport web to form a sequence of sintered powder layers defining the cross sections of the part, the sequence of sintered powder layers comprising a first sintered powder layer, intermediate sintered powder layers, and a last sintered powder layer; and a transfer station comprising a vibratory horn movable relative to the support substrate to form a transfer nip within which the first of the sintered powder layers is fuseable upon the support substrate to form a first fused layer, and each of the intermediate sintered powder layers is fuseable to a preceding fused layer, and the last sintered powder layer is fuseable to a last preceding fused layer, wherein fusing of the sequence of sintered layers form the part.

The transport web may be deliverable by the web delivery system along a delivery axis, with the vibratory horn being comprised of an elongated distal end contactable with the transport web and having a longitudinal axis transverse to the delivery axis of the web. The apparatus may be further comprised of a compliant material joined to a distal end of the vibratory horn. The apparatus may be further comprised of a reciprocator configured to move the support substrate synchronously with motion of the transport web. The powder generation may be a xerographic toner powder generation system.

In accordance with the present disclosure, there is also provided a method for making a part. The method comprises depositing a first layer of powder on a transport web substrate; sintering the first layer of powder to form a first sintered layer on the transport web substrate; conveying the first sintered layer to a location proximate to a support substrate; contacting a vibratory horn with the transport web substrate at the location of the first sintered layer on the transport web substrate, and moving the vibratory horn to cause the transport web substrate and first sintered layer to move to a location wherein the first sintered layer is in contact with the support substrate; and oscillating the vibratory horn at a frequency to cause fusing of the first sintered layer into a first fused layer of the part, the first fused layer removably joined to the substrate.

For a part comprised of at least two layers, the method further comprises depositing a second layer of powder on the transport web substrate; sintering the second layer of powder on the transport web substrate to form a second sintered layer on the transport web substrate; conveying the second sintered layer to the location proximate to the support substrate; contacting the vibratory horn with the transport web substrate at the location of the second sintered layer on the transport web substrate, and moving the vibratory horn to cause the transport web substrate and second sintered layer to move to a location wherein the second sintered layer is in contact with the first fused layer; and oscillating the vibratory horn at a frequency to cause fusing of the second sintered layer into a second fused layer of the part joined to the first fused layer of the part.

For a part comprised of a sequence of layers, the method further comprises depositing a sequence of layers of powder on the transport web substrate; sintering the sequence of layers of powder on the transport web substrate to form a sequence of sintered layers on the transport web substrate; for each layer of the sequence of sintered layers, conveying that layer of the sequence of sintered layers to the location proximate to the support substrate; for each layer of the sequence of sintered layers, contacting the vibratory horn with the transport web substrate at the location of that sintered layer on the transport web substrate, and moving the vibratory horn to cause the transport web substrate and that sintered layer to move to a location wherein that sintered layer is in contact with a preceding fused layer; and oscillating the vibratory horn at a frequency to cause fusing of that sintered layer into an additional fused layer of the part joined to the preceding fused layer of the part.

The method may further comprise disposing a compliant layer between the vibratory horn and the transport web substrate. Such a method may further comprise moving the support substrate and at least the first fused layer of the part synchronously with motion of the transport web substrate while contacting the vibratory horn with the transport web substrate at the location of one of the sintered layers on the transport web substrate, and moving the vibratory horn to cause the transport web substrate and one of the sintered layer to move to a location wherein the one of the sintered layers is in contact with the support substrate or a preceding fused layer, and oscillating the vibratory horn at a frequency to cause fusing of the one of the sintered layers into an additional fused layer of the part. The method may further comprise moving the transport web substrate and first sintered layer of the part in a direction that is transverse to the longitudinal axis of a distal end of the vibratory horn that is contacted with the transport web substrate.

The sintering may be performed by at least one of heating the first portion of the powder on the transport web substrate and exposing the first portion of the powder on the transport web substrate to a solvent. The method may further comprise generating the first portion of powder using a xerographic toner powder generation process prior to depositing the first layer of the powder on the transport web substrate. In certain embodiments, the vibratory horn may be oscillated at a frequency of between 15 kHz and 40 kHz.

In accordance with the present disclosure, there are provided alternative apparatus and methods for fabricating a part, by using “far-field” welding of powder layers. The apparatus is comprised of a support plate, a transport web delivery system, a powder imaging system, a sintering station, and a transfer station. The powder imaging system is configured to deposit a sequence of imaged layers of powder on a sequence of areas of the transport web delivered by the web delivery system. The sintering station is configured to sinter the sequence of imaged layers of powder on the transport web to form a sequence of sintered powder layers, the sequence of sintered powder layers comprising a first sintered powder layer, intermediate sintered powder layers, and a last sintered powder layer. The transfer station is comprised of a backing member and vibratory transducer coupled to the support plate. The vibratory transducer and support plate are movable toward the transport web and backing member to form a first layer transfer nip within which the first of the sintered powder layers is fuseable upon the support plate to form a first fused layer. Additionally, the vibratory transducer, support plate, and first and subsequent fused layers are movable toward the transport web to form an intermediate transfer nip within which each of the intermediate sintered powder layers is fuseable to a preceding fused layer; and the vibratory transducer, support plate, and first and intermediate fused layers are movable toward the transport web to form a last transfer nip within which the last sintered powder layer is fuseable to a last preceding fused layer, wherein fusing of the sequence of sintered layers form the part.

The transfer nips are formed between the transport web and a part receiving surface of the support plate. In certain embodiments of the apparatus, the vibratory transducer may be coupled to the part receiving side of the support plate. In other embodiments, the vibratory transducer may be coupled to the part receiving side of the support plate.

In certain embodiments, the backing member is movable laterally along the transfer web to cause the transfer nip to move laterally relative to the part. Such a backing member may be a cylinder having an axis of rotation parallel to a plane defined by the support plate, which cylinder may be rotatable around its axis of rotation while translating laterally along the transfer web. The cylinder may be comprised of a compliant outer layer.

In a method of making a part using the above apparatus that utilizes far-field welding, the method comprises depositing a first layer of a powder on a transport web substrate; sintering the first layer of powder to form a first sintered layer on the transport web substrate; conveying the first sintered layer to a location proximate to a support plate; coupling a vibratory transducer to the support plate and moving the vibratory transducer and support plate toward the transport web substrate to form a first layer transfer nip at an edge of the first sintered layer and between a backing member and the support plate; oscillating the vibratory transducer at a frequency to cause fusing of the first sintered layer into a portion of a first fused layer of the part within the nip; and moving the backing member laterally along a plane parallel to the plane defined by the support plate to cause the nip to move laterally along the first sintered layer and cause the first sintered layer to fuse, forming the first fused layer removably joined to the substrate.

For adding a second layer to the part, the method further comprises depositing a second layer of powder on the transport web substrate; sintering the second layer of powder on the transport web substrate to form a second sintered layer on the transport web substrate; conveying the second sintered layer to a location proximate to the first fused layer; moving the vibratory transducer, support plate, and first fused layer toward the transport web substrate to form a second layer transfer nip at an edge of the second sintered layer and between the backing member and the first fused layer; oscillating the vibratory transducer at a frequency to cause fusing of the second sintered layer into a portion of a second fused layer of the part within the nip; and moving the backing member laterally along the plane parallel to the plane defined by the support plate to cause the first layer transfer nip to move laterally along the second sintered layer and cause the second sintered layer to fuse, forming the second fused layer joined to the first fused layer.

For adding a sequence of additional layers to the part, the method further comprises depositing a sequence of layers of powder on the transport web substrate; sintering the sequence of layers of powder on the transport web substrate to form a sequence of sintered layers on the transport web substrate; and for each layer of the sequence of sintered layers, conveying that sintered layer to a location proximate to the preceding fused layer; moving the vibratory transducer, support plate, and fused layers toward the transport web substrate to form an additional layer transfer nip at an edge of that sintered layer and between the backing member and the preceding fused layer; oscillating the vibratory transducer at a frequency to cause fusing of that sintered layer into a portion of an additional fused layer of the part within the nip; and moving the backing member laterally along the plane parallel to the plane defined by the support plate to cause that layer transfer nip to move laterally along that sintered layer and cause that sintered layer to fuse, forming the additional fused layer joined to the preceding fused layer of the part.

In certain embodiments, the vibratory transducer may be oscillated at a frequency of between 15 kHz and 40 kHz.

In other embodiments of the apparatus using far-field welding, the backing member may be comprised of a conformable pressure plate contactable with an entire area of the web substrate opposed to an upper surface of the part when receiving an intermediate or last sintered layer of the part. In a method of making a part using such an apparatus, the method comprises depositing a first layer of a powder on a transport web substrate; sintering the first layer of powder to form a first sintered layer on the transport web substrate; coupling a vibratory transducer to a support plate; conveying the first sintered layer to a location between the support plate and a pressure plate comprising a conformable compression member; moving the pressure plate toward the transport web substrate to cause the entire first sintered layer to contact the support plate and cause the conformable compression member to contact an entire area of the web substrate in contact with the first sintered layer; and oscillating the vibratory transducer at a frequency to cause the first sintered layer to fuse into a first fused layer removably joined to the substrate.

For adding a second layer to the part, the method further comprises depositing a second layer of powder on the transport web substrate; sintering the second layer of powder on the transport web substrate to form a second sintered layer on the transport web substrate; conveying the second sintered layer to a location between the first fused layer and the pressure plate; moving the pressure plate toward the transport web substrate to cause the entire second sintered layer to contact the first fused layer and cause the conformable compression member to contact an entire area of the web substrate in contact with the second sintered layer; and oscillating the vibratory transducer at a frequency to cause the second sintered layer to fuse into a second fused layer joined to the first fused layer.

For adding a sequence of additional layers to the part, the method further comprises depositing a sequence of layers of powder on the transport web substrate; sintering the sequence of layers of powder on the transport web substrate to form a sequence of sintered layers on the transport web substrate; and for each layer of the sequence of sintered layers, conveying that sintered layer to a location between the preceding fused layer and the pressure plate; moving the pressure plate toward the transport web substrate to cause that entire sintered layer to contact the preceding fused layer and cause the conformable compression member to contact an entire area of the web substrate in contact with that sintered layer; and oscillating the vibratory transducer at a frequency to cause that sintered layer to fuse into an additional fused layer joined to the preceding fused layer.

### BRIEF DESCRIPTION OF THE DRAWINGS

The present disclosure will be provided with reference to the following drawings, in which like numerals refer to like elements, and in which:

FIG. 1 is a schematic diagram of a first embodiment of an apparatus for fabricating an object by transwelding of plastic powder;

FIG. 2 is a perspective view of an ultrasonic horn for use in embodiments of the invention;

FIG. 3 is a schematic diagram of a second embodiment of an apparatus for fabricating an object by transwelding of plastic powder.

FIG. 4 is a schematic diagram of an experimental transwelding apparatus, the use of which resulted in the discovery of a “far-field” transwelding effect;

FIG. 5A is a schematic diagram of a third embodiment of an apparatus for fabricating an object by transwelding of plastic powder, depicted at the beginning of transwelding of an object layer;

FIG. 5B is a schematic diagram of the embodiment of the apparatus of FIG. 5A, depicted approximately midway through transwelding of an object layer;

FIG. 6 is a schematic diagram of a fourth embodiment of an apparatus for fabricating an object by transwelding of plastic powder; and

FIG. 7 is a schematic diagram of a fifth embodiment of an apparatus for fabricating an object by transwelding of plastic powder.

The present invention will be described in connection with certain preferred embodiments. However, it is to be understood that there is no intent to limit the invention to the embodiments described. On the contrary, the intent is to cover all alternatives, modifications, and equivalents as may be included within the spirit and scope of the invention as defined by the appended claims.

### DETAILED DESCRIPTION

For a general understanding of the present invention, reference is made to the drawings. In the drawings, like reference numerals have been used throughout to designate identical elements. In the following disclosure, the present invention is described in the context of its use in transwelding plastic powder materials. However, it is not to be construed as being limited only to use in welding plastic powders. The invention is adaptable to any use in which fusion of powders of solid materials is desirable in order to form a solid object, including plastic powders, metal powders, and mixtures of powders of plastics, metals, and other friable materials.

Additionally, in the present disclosure, certain components may be identified with adjectives such as “top,” “upper,” “bottom,” “lower,” “left,” “right,” etc. These adjectives are provided in the context of the orientation of the drawings, which is arbitrary. The description is not to be construed as limiting the various apparatus disclosed herein to use in a particular spatial orientation. The instant apparatus may be used in orientations other than those shown and described herein.

It is also to be understood that any connection references used herein (e.g., attached, coupled, connected, and joined) are to be construed broadly and may include intermediate members between a collection of elements and relative movement between elements unless otherwise indicated. As such, connection references do not necessarily imply that two elements are directly connected and in fixed relation to each other.

As used herein, the term “powder” is meant to indicate any solid material that has been subdivided into small particles, which are sufficiently small so as to render them flowable by mechanical action or fluidization with a gas. The particles of a powder may be spherical, oblong, or of various other geometrical shapes such as crystalline shapes, and may be of a non-uniform size distribution.

As used herein, the term “transwelding” is meant to indicate a process operation in which a first material, which is conveyed by, for example, a donor web, is contacted with the surface of a second material, and is fused with that second material by applying a welding device having a width greater than, or at least equal to the width of the surface of the second material in a manner such that the welding of the first material to the second material occurs over the entire width of the surface of the second material.

As used herein, the term “ultrasonic” in reference to an energy source is meant to indicate a mechanical source of energy imparted by oscillations of a vibrating member at a frequency of between 15 kHz to 40 kHz. In certain embodiments of the apparatus and methods disclosed herein, operation at frequencies outside of this range may be operable.

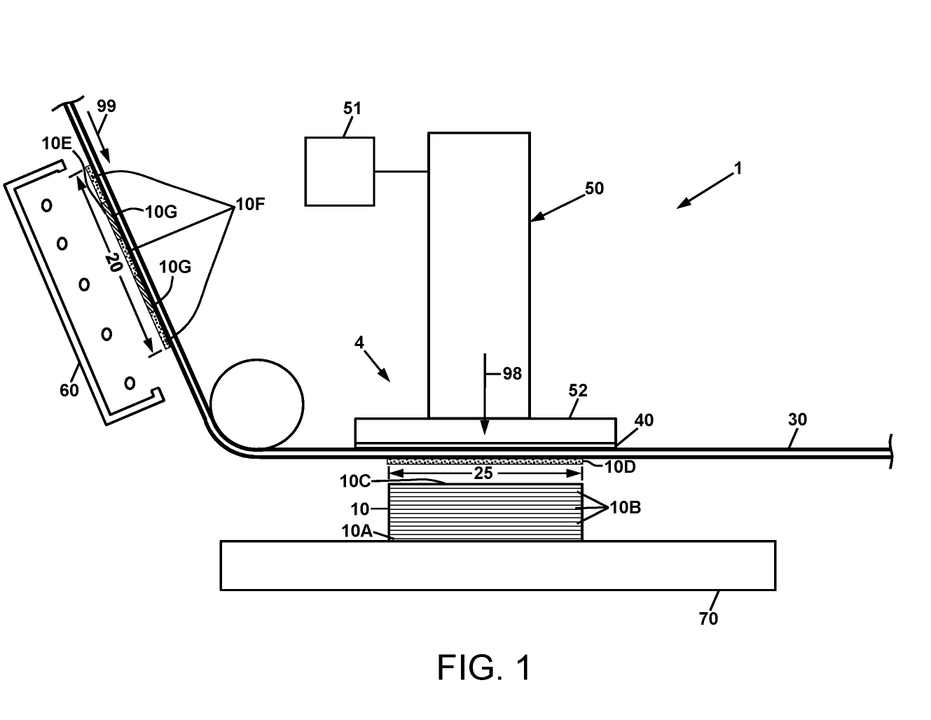

Several embodiments of apparatus and methods for transwelding plastic powder are disclosed herein. Referring to FIG. 1, and in a first embodiment shown therein, an object or part 10 is depicted as being fabricated layer-by-layer upon a support substrate 70 using an apparatus 1. Powder is deposited upon a transport material 30, which may be a flexible web material that is unwound from a first roll (not shown) and rewound on a second roll (not shown) after conveying a layer of powder material to the part 10 being fabricated. Alternatively, the transport material may be a continuous loop or belt of flexible web material that is continuously cycled past the part 10 being fabricated. The material of the support substrate 70 is chosen such that the first layer 10A of the part 10 adheres to the support substrate 70 with sufficient strength so that subsequent layers can be added to form the overall part 10.

In a first operation of the fabrication of part 10, a sequence of layers of powder are transferred to the transport web 30, which is movable as indicated by arrow 99. In certain embodiments, the powder may be transferred to the transport web 30 by methods used in electrophotographic imaging, such as electrostatic transfer of xerographic toner, which is a type of ink in powder form. Such methods and related apparatus are described in commonly owned U.S. provisional patent Application No. 62/103,269, the disclosure of which is incorporated herein by reference. Thus in such embodiments, each of the layers of powder in the sequence of layers is “imaged” onto the transport web 30, transported to a location proximate to the support substrate 70, and transferred as a sequence of layers 10A, 10B, and 10D onto the support substrate 70 to form the overall part 10. In certain embodiments, the toner may be an acrylonitrile butadiene styrene (ABS) toner. Following deposition of the toner as one of the layers 10A, 10B, or 10D of the part, the toner layer may be electrically discharged by various discharge means used in xerography. In other embodiments, the powder may be deposited on the transport web using an apparatus and method as disclosed in the aforementioned U.S. Pat. No. 8,771,802.

The transport web 30 may be operated with continuous motion, or with intermittent motion, i.e., an indexed motion having starts and stops. In the embodiment depicted in FIG. 1, the part 10 is fabricated layer-by-layer with indexed motion of the transport web 30. Individual layers 10B are added to form the part 10. FIG. 1 depicts a point in time at which the first layer 10A of the part 10 has been deposited on the support substrate, a sequence of additional layers 10B have been deposited onto the first layer 10A. A new layer 10D of powder that is disposed on region 25 of the transport web 30 is to be added to the part 10. Region 25 is aligned or in positional registration with the part 10. To add the layer 10D to the part 10, an ultrasonic horn 50 is advanced as indicated by arrow 98, moving the web 30 and powder of layer 10D downwardly such that the layer 10D is in contact or close proximity with the uppermost layer 10C of part 10. The ultrasonic 50 horn may include an end plate 52 that is sized so as to extend beyond the edges of the part 10, in order to ensure that all of the powder in the layers is added to the part 10.

With the powder of layer 10D in contact or close proximity with the uppermost layer 10C of part 10, the ultrasonic horn 50 is operated by a control system 51. Ultrasonic energy is imparted into the powder of layer 10D, causing it to be transwelded, i.e., transferred to and fused with the uppermost layer 10C of part 10. The ultrasonic horn 50 is then retracted, and the transport web 30 is indexed again to advance region 25 of the web 30 conveying another portion of powder 10E to be added to the part 10.

In certain embodiments, the powder to be added to the part 10 as a layer may be sintered on the transport web 30, prior to it being added to the part 10. The Applicants have discovered that such an operation is beneficial in that it solves the problem of airborne dispersal of the powder during the ultrasonic transwelding of the powder to the part 10, which often occurs if sintering is not done. In certain initial studies of the joining of layers of plastic to form a part, ultrasonic welding of thin sheets of plastic was performed. Subsequently, ultrasonic welding of ABS toner (powder) was attempted instead of welding of thin solid sheets. In making such attempts to ultrasonically weld powder, the problem of airborne dispersal of the powder was discovered: significant amounts of ABS toner were observed being ejected from the nip between the ultrasonic horn and the substrate. Repeated experiments at various process conditions led to the conclusion that the ultrasonic vibrations from the ultrasonic horn were quite powerful with respect to the toner, and were causing the ejection from the nip and dispersion into the nearby air.

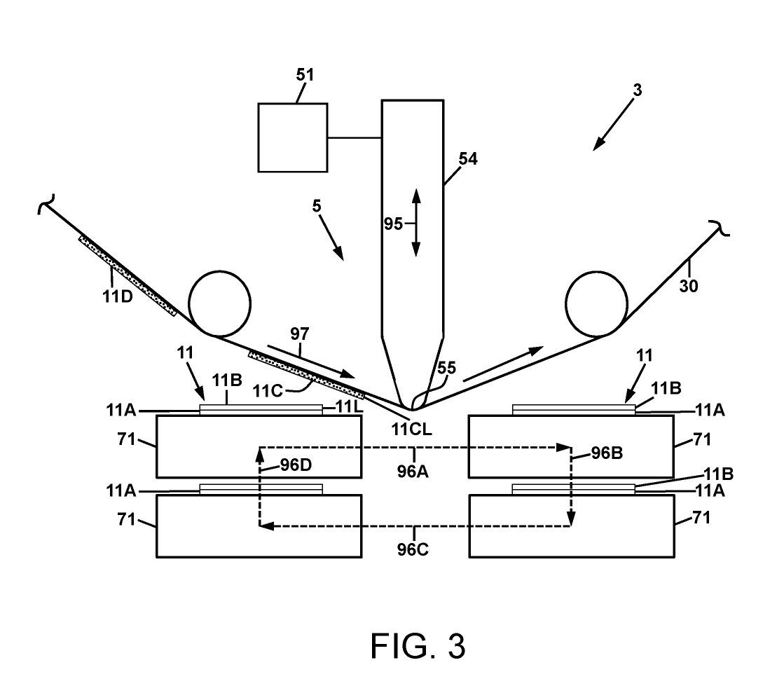

As a countermeasure, the Applicants hypothesized that it would be beneficial to temporarily adhere the toner to the donor surface by some suitable means. Tacking the toner to the donor sheet via some mild heating was tried using a hot plate and that appeared to solve the problem. Subsequently, upon microscopic observation and with more controlled experiments, it became apparent that sintering was the most desirable way of adhering the toner to the donor surface, and, combined with using a low surface energy donor material (e.g., the donor material of transport web 30 of FIGS. 1 and 3), gave the most reliable results. In contrast, when a donor material of nominal surface energy was used, then the sintered deposit would not release from the donor and no transfer would take place. Examples of suitable low surface energy materials for the donor, i.e., the transport web 30, are provided subsequently herein. It is to be understood that these cited materials are to be considered exemplary and not limiting.

To accomplish sintering of the powder on the transport web 30, a heater may be provided, such as a heating element (not shown) that may be in contact with the transport web on the side that is opposite of the side that is conveying the powder. In the embodiment depicted in FIG. 1, a radiative heater 60 is provided to directly radiatively heat and sinter the powder (such as powder portion 10E) that is on the transport web 30 in region 20. In another embodiment (not shown) in which the powder material is soluble in a particular solvent, a source of vapor of that solvent is provided upstream of the transwelding station 4 to cause sintering of the powder on the transport web 30.

In one exemplary embodiment, an ABS toner was used as a powder material. Prior to transfer of layers of the toner to form the part 10, the powder layers were heated to about 130° C. to achieve sintering. The resulting sintered layers were allowed to cool to room temperature before transwelding. It was discovered that in some instances, the sintering process may cause the toner to adhere to the transport web 30; however, the toner layer needs to release from the transport web 30 during the transwelding process in order to form the particular layer on the part 10. In order to meet this requirement, the transport web 30 may be made of a suitable low surface energy material, such as Teflon® FEP fluoropolymer-coated Kapton®. Other materials are contemplated, with the operative requirement that such materials are not degraded or otherwise affected by heat or pressure, or by the ultrasonic energy during the transwelding process.

In certain embodiments, the most rapid part building process using ultrasonic welding employs a full-area weld, creating a “stamp and repeat” approach as described above. If a full-area weld is employed, i.e. if the surface of the ultrasonic horn is planar and large enough to cover the entire part in fabrication, the Applicants have discovered that another problem arises, which is macro uniformity of contact. Even very slight variations (less than 25 μm) in the flatness of either surface (part 10 or ultrasonic horn 50 or plate 52) results in a raised pressure point, which prevents contact to most of the remaining intended weld area, leaving this area un-welded.

In order to solve this problem, a compliance pad or layer 40 may be provided as part of the transwelding station 4. The compliance layer may be provided contiguous with the bottom surface of the end plate 52 of the ultrasonic horn 50. Without wishing to be bound to any particular theory, the Applicants believe that the compliance layer 40 improves macro-uniformity of pressure in the welding nip, i.e., the portion of the transport web 30 that releases the sintered layer portion to the part 10 during transwelding to add another layer to the part 10. Thus for compliant layer 40, the Applicants select a material that is soft or compliant in the time frequency domain of the ultrasonic nip dwell time (e.g., 0.1-2 sec), but stiff or non-compliant in the ultrasonic frequency time domain (e.g., 0.01-0.10 msec).

In certain embodiments, the part 10 may be heated during the transwelding of successive layers 10A and 10B. The heating may be provided by a heater (not shown) that heats the support substrate 70. The Applicants believe that with some powders, heating of the part 10 facilitates the fusing of the powder into a new layer during transwelding. The temperature of heating is chosen depending upon the particular powder material that is being transwelded.

In one exemplary embodiment, a transwelding apparatus 1 with the following features was provided having a support substrate 10 with a heater for heating the part 10 during transwelding, and a sheet of nitrile rubber, 112 microns (μm) thick, and of durometer 30 Shore A, as a compliant layer 40. Experimental trials were conducted with this apparatus 1 using an ABS toner to fabricate an ABS part 10. During successive additions of layers, the part 10 was heated to about 95° C. Successful transwelding of additional layers to the part 10 were achieved at various transwelding conditions. Some successful transwelds were achieved using a solid flat-surfaced ultrasonic horn operated at 20 KHz with a 1:1 booster, and 750 Joules of energy applied for 900 milliseconds at 90 pounds per square inch (psi) of nip pressure, i.e., the pressure applied over the surface area of the layer being added to the part. Other successful transwelds with this ultrasonic horn were achieved with conditions of 450 Joules energy, 430 msec of duration and 68 psi of nip pressure. The Applicants believe that other frequencies may be used with appropriately differing set points to accomplish the same results. The thicknesses of the transwelded layers were approximately 25 μm.

In other embodiments, a second powdered material may be co-deposited with the primary powder material that forms the part 10. The second powder material functions as a support polymer. It is used in conjunction with the primary powder material to provide structural support during the fabrication process, and is transwelded along with the primary material. Subsequently, the support polymer may be dissolved or discarded when fabrication is complete, leaving behind the desired part with hollow cavities previously occupied by the second powdered material. In that manner, it is further noted that a layer of powder to be transwelded to the part 10 does not necessarily have to be a uniform layer. The layer may be an irregular layer as shown for irregular layers 10E in FIG. 1. Layer 10E is comprised of primary powder material 10F (indicated by dotted fill), and support material 10G (indicated by line cross-hatching). Such layers may be provided on the transport web by the methods and apparatus disclosed in the aforementioned U.S. Pat. No. 8,771,802 and commonly owned U.S. Provisional Application No. 62/103,269. Thus the powder layer, such as layer 10E, may be discontinuous, i.e., it may have isolated regions (islands) and its shape may change from layer to layer. Therefore, a part 10 with an irregular three-dimensional shape may be fabricated.

In certain embodiments, the primary powder to be transwelded may include metallic constituents. In certain embodiments, the primary powder may be electrically conductive.

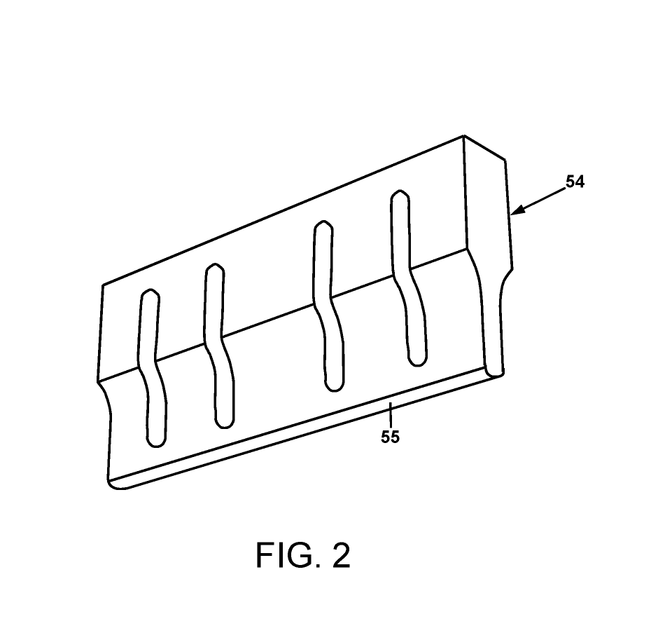

FIG. 3 is a schematic diagram of a second embodiment of an apparatus for transwelding plastic powder. The apparatus 3 may be used in a continuous part fabrication operation, as compared to the indexed static step-and-repeat operation of the apparatus 1 of FIG. 1. The apparatus 3 may be comprised of an ultrasonic horn 54 as shown in FIG. 2 for providing ultrasonic energy to perform the transwelding. The ultrasonic horn 54 may have a radiused head 55 for smooth transport of the toner-bearing web across the horn face.

In a method practiced using the apparatus 3 of FIG. 3, portions of powder 11C and 11D are shown as having been deposited on the transport web 30, for the purpose of subsequently being transwelded to the part 11 being fabricated. The portions 11C and 11D may be deposited by a xerographic toner application process or by the methods disclosed in the aforementioned U.S. Pat. No. 8,771,802 and commonly owned U.S. Provisional Application No. 62/103,269. The portions 11C/11D to be deposited may be sintered by suitable heat and/or solvent sources (not shown) as described for the method practiced using apparatus 1 of FIG. 1.

The transport web 30 conveys the portions 11C/11D as indicated by arrow 97 to the transwelding station 5, which is comprised of the ultrasonic horn 54 and its ultrasonic drivers and control system 51. The transwelding station 5 is further comprised of a conveyor or reciprocator (not shown), which traverses the support substrate 71 and the part 11 being fabricated along the cyclical path indicated by arrows 96A-96D. The ultrasonic horn 54 may be advanced and retracted to provide proper nip geometry as indicated by bidirectional arrow 95. The motion of the ultrasonic horn 54 and the reciprocating motion of the support substrate 71 and part 11 being fabricated are synchronized with the conveyance of the powder portions that are deposited on the transport substrate 30 so that a powder portion to be added and the part 11 arrive concurrently at the nip and are contacted by the ultrasonic horn 54. For example, referring to FIG. 3, the leading edge 11CL of the powder portion 11C to be transwelded arrives at the head 55 of the ultrasonic horn 54 at the same time that the leading edge 11L of the top layer 11B of the part 11 being fabricated arrives at the horn head 55. As the transport web 30 continues to advance the powder portion 11C to the horn head 55, the conveyor continues to translate the support substrate 70 and part 11 synchronously so that the powder portion 11C is transwelded to the part 11. Following the transwelding, the support substrate 71 and part 11 follow the return path indicated by arrows 96B-96D, as controlled by the reciprocator (not shown), to return to the upper left build cycle start position, ready for the next layer 11D to be transwelded. It is noted that the return path does not need to be a rectangular path as indicated in FIG. 3. Additionally the reciprocator may carry multiple support substrates 71, such that a plurality of parts 11 may be in fabrication at the same time.

The use of a linear ultrasonic horn 54 with a radiused head 55 provides certain advantages over the apparatus 1 of FIG. 1. Although controlling the registration of the support substrate 71 and part 11 with the incoming layer to be added is more difficult than the static arrangement of the apparatus 1 and related method, the transwelding benefits are significant. The Applicants have discovered through experimentation that because the radiused head 55 of the horn 54 has reduced contact area during transwelding, the total force applied to the contact nip can be reduced while achieving the desired nip pressure. Because the contact is largely linear, mechanical alignment ensuring uniform pressure along the nip is also much easier. The Applicants have further discovered that the compliance layer 40 of apparatus 1 (such as the nitrile rubber sheet described previously) is not needed for the method using the apparatus 3. Additionally, it was discovered that the temperature of operation could be reduced. In one experimental trial in which the part 11 being fabricated was ABS, the part 11 was heated to only 30° C. The Applicants have found that maintaining the part 11 in a cooler and harder state, versus warmer and softer in the experiments described previously with reference to FIG. 1, prevented any “plowing” or deformation of the part surface by the ultrasonic head 55. Instead, a uniform, approximately 25 μm thick layer of ABS was transferred and bonded to the harder surface of part 11, as desired. In one experimental trial, a process speed of 0.1 inches/sec, an applied force of 38 lb., and 20 KHz ultrasonic frequency applied to a 1.25″×0.125″ aluminum ultrasonic horn provided successful continuous welding conditions for ABS material. The Applicants note that further processing (e.g., cooling) of a transwelded layer on a part may also be accomplished during the return cycle 96B-96D, if desired. Trade-offs among pressure, temperature, ultrasonic energy applied, and process speed may be readily made to meet part fabrication objectives with ABS and other powder materials.

In accordance with the present disclosure, an alternative method has been devised to laminate and/or weld a thin layer of plastic to a part being fabricated of the same or a similar material. The method employs ultrasonic vibratory motion to mimic the effect of welding via an ultrasonic horn. However, in contrast to the embodiments disclosed above and depicted in FIGS. 1-3, no ultrasonic horn imparting vibratory energy at a nip directly into the material to be welded to cause direct welding to the part at the nip is necessary. The Applicant has discovered that by vibrating the workpiece with respect to a fixed backing object which in turn supports the thin layer being welded, effective welding is enabled for certain classes of materials. This method is particularly suited to 3-D printing applications, although not exclusively so.

It is known that an ultrasonic horn focuses vibratory mechanical energy to well-defined regions to effect welding of materials via localized heating. When the ultrasonic horn is a horn 54 as depicted in FIG. 2, the welding occurs at a nip that is formed between the support substrate or surface of the part being fabricated and the surface of the transport web that is opposite the head 55 of the horn 54. However, the Applicant has discovered that by restricting the class and thickness of materials to be welded, ultrasonic “far-field” welding may be used to achieve transfer and welding of the thin layers typical of 3-D printing.

As used herein, the term “far field” is meant to indicate that the distance between a source of ultrasonic energy and the area of material being welded to the part being fabricated is at least 6 millimeters. In certain embodiments, distances between 6 mm and 100 mm have been demonstrated to be effective for achieving welding. Although the parameters that are operable for far field ultrasonic welding may be somewhat narrower than conventional direct ultrasonic welding using an ultrasonic horn, the overall far field ultrasonic welding method still permits a viable approach for many 3-D printing systems, or any process that directed to welding very thin layers (approx. 0.001 inch thick), whether in sequential layers or a single layer.

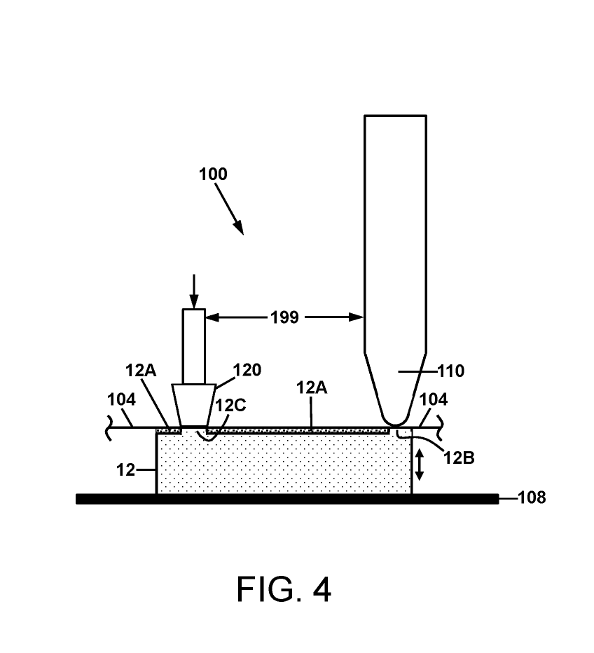

FIG. 4 is a schematic illustration of an experimental apparatus 100 by which the far-field welding effect was discovered. In an experiment, a thin layer 12A of ABS, sintered on 5 mil thick Teflon®-coated Kapton® web substrate 104, was held in contact with a solid block 12 of ABS (the object to be fabricated) disposed upon a support plate 108, and a 20 KHz ultrasonic horn 110 was placed in contact with the layer 12A of ABS to transweld it to the object 12, also referred to as a “workpiece, or “product.” It was observed that in addition to the welding of the ABS layer 12A occurring underneath the horn 110 in region 12B, welding also unexpectedly occurred in a region 12C underneath a hold-down clamp 120 that was used to stabilize the ABS layer 12A during the welding process. In subsequent experiments, the lateral distance 199 from the clamp 120 to the horn 110 was varied from 2 inches to 4 inches, with little to no deleterious effect on the welding performance at the clamp region 12C. Without wishing to be bound to any particular theory, the Applicant believes that the contact of the horn with the sintered layer 12A of ABS at region 12B caused vibrations in the support plate 108, or the product 12, or both, which propagated to the region 12C underneath the clamp 120, the pressure from which enabled localized heating and effective transwelding thereunder. In the experiments, the hold-down clamp was formed of an elastomer having a durometer of 88 Shore A, and pressure under the clamp was 16 pounds per square inch.

Although the mechanism for far-field ultrasonic welding is likely the same as for conventional ultrasonic welding, the Applicant believes that uniqueness of its applicability in 3-D printing derives from several material properties and procedures, all of which are preferably simultaneously present. Such properties and procedures are as follows:
The material to be welded should be relatively easily welded, i.e. the particles of the material and/or the semi-continuous regions of sintered material should be amenable to fluidization upon the delivery of ultrasonic energy, so as to flow and consolidate into a continuous liquid or semi-liquid phase. It has been observed that the exemplary material ABS, with a glass transition temperature of about 100° C., does not require high localized heating, and therefore is a weldable material using this method.
The material should be relatively stiff, i.e., inelastic, so that vibrations imparted by the ultrasonic energy source are not damped out and propagate sufficiently to the far field welding site. The modulus of elasticity of the exemplary material ABS is typically between 1.7 and 2.8 gigapascals depending upon temperature and molecular weight; other materials having comparable moduli would likely satisfy this metric.
The layer to be added must be sufficiently thin so as to enable welding of the entire cross-section of the layer. This also keeps welding energy requirements low. A thickness range of 5 to 100 micrometers is expected to be effective for welding ABS and other similar materials.
The layer should be sintered or otherwise partially fused into a non-friable state before welding, to avoid the powder of the layer from becoming aerosolized.
The transport web should be of a low-surface-energy material, so that as the powder layer is welded to the object, it also releases from the transport web.
The transport web should be inelastic, so that strong and uniform pressure is maintained on the sintered powder and also so that so that vibrations imparted by the ultrasonic energy source are not damped out and propagate through the transport web during the welding process. The modulus of elasticity of the exemplary web material Kapton polyimide is typically between 2.0 and 2.5 gigapascals depending upon temperature and molecular weight; other materials having comparable moduli would likely satisfy this metric.
The applied pressure should have low spatial and temporal frequency compliance, to ensure intimate contact across the entire area to be welded.

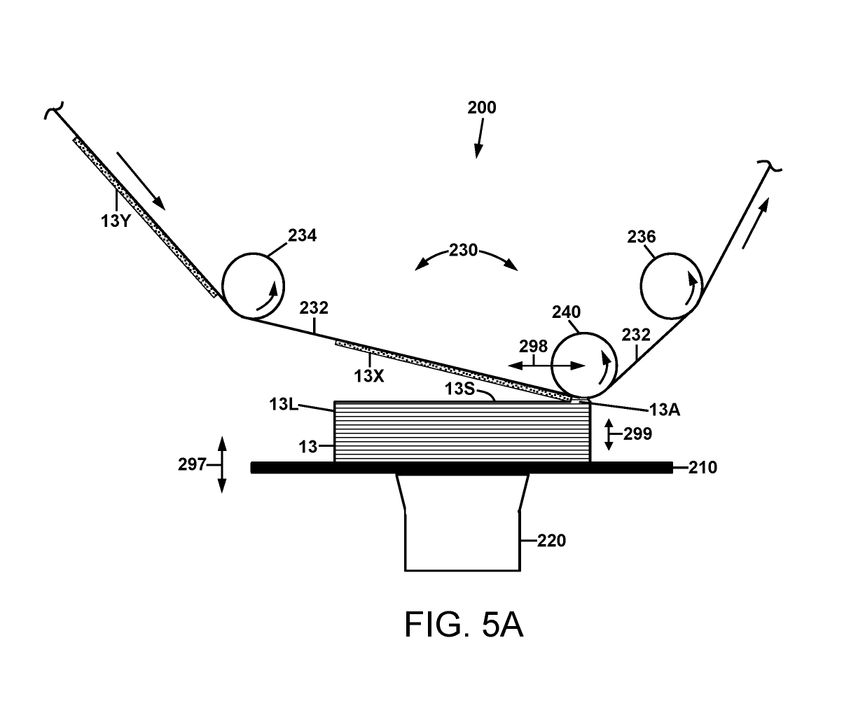

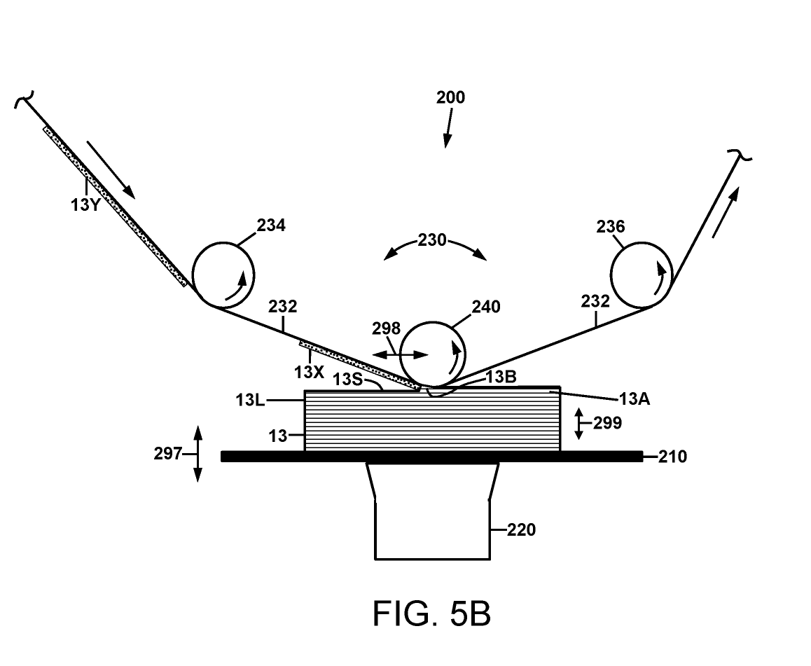

Based upon the above-described discovery of the far-field welding effect, the Applicant has made an apparatus for use of the effect in fabricating an object. One exemplary embodiment of the apparatus is depicted in FIG. 5A. The apparatus 200 is comprised of a support plate 210, a vibratory transducer 220, and a web delivery system 230. The support plate 210 receives the first layer of material as it is transwelded and holds the object 13 as successive layers of material are transwelded to form the complete object 13. The vibratory transducer 220 provides ultrasonic energy, and is coupled to the support plate 210 so as to impart mechanical vibration indicated by bidirectional arrow 299 into the support plate 210 in a direction perpendicular to the surface 13S that receives the next transwelded layer of the object 13. The ultrasonic energy propagates through the partially formed object sufficiently to enable transwelding of the next layer 13X to the object 13.

The transport web delivery system 230 is comprised of a transport web 232, a web supply roll (not shown), a web windup roll (not shown), and a web drive (not shown). Alternatively, the transport web 232 may be a loop or belt (not shown) of web material, obviating the need for a web supply roll and web windup roll. The transport web delivery system 230 is further comprised of web rollers 234 and 236 positioned to allow traversal of the web 232 along the surface 13S of the object 13 by backing member 240 during transwelding of the next layer 13X into an additional fused layer added to the object 13. In certain embodiments, the transport web 232 may be a thin sheet metal web, or a web of polyimide polymer such as Kapton®. The web 232 may be further comprised of a fluoropolymer coating such as Teflon® to provide a low surface energy that facilitates release of the powder layers from the web 232 when they are transwelded to form the object 13.

The transport web delivery system 230 sequentially delivers sintered layers of material to be transwelded to the object 13, beginning with a first sintered layer (not shown) that is transwelded into a first fused layer. In the apparatus 200 and method depicted therein, the object 13 is partially formed by transwelding a sequence of fused layers. The web delivery system has indexed the web 232 with the next layer 13X into position to be transwelded. Additionally, the subsequent layer 13Y to be transwelded has been disposed on the web 232. The layers 13X and 13Y may be provided by powder layer forming and sintering devices (not shown) as described previously for the methods and apparatus of FIGS. 1 and 3. The powder layer forming device may be an electrophotographic device. The apparatus 200 may include a heater 60 (FIG. 1) or a solvent vapor source for sintering the powder layers 13X and 13Y as described previously, prior to transwelding them to the object 13.

Referring to FIG. 5A, at the beginning of the process of transwelding the layer 13X to the object 13, the backing member 240 is positioned to form a nip between the web substrate 232 and the top surface 13S of the object. The vibratory transducer 220 imparts ultrasonic energy into the support plate 210, which propagates through the partially formed object 13. With the backing member 240 being rigidly held, transwelding of the layer 13X occurs at region 13A in the transfer nip that is formed perpendicular to the indexing motion of the web substrate 232.

The transwelding of the layer 13X to the object 13 is depicted in a partially completed stage in FIG. 5B. The backing member 240 is movable in a lateral direction relative to the top surface 13S of the object 13, as indicated by bidirectional arrow 298. The full area of the layer 13X is transwelded to the object 13 by traversing the backing member 240 laterally along the top surface 13S of the object 13, thereby transwelding the layer 13X at region 13B as the transfer nip moves laterally. When the backing member 240 has traversed laterally to the edge 13L of the object, the transwelding of layer 13X into an additional fused layer portion of object 13 is completed.

The support plate 210, vibratory transducer 220, and object 13 are movable vertically as indicated by bidirectional arrow 297 by a drive system (not shown). Thus the plate 210, transducer 220, and object 13 may be lowered to provide clearance between the top surface 13S of the object 13 and the web substrate 232, so that the backing member 240 can be returned to the transwelding starting position of FIG. 5A. The web substrate 232 is indexed to place the next sintered layer 13Y in position for transwelding to object 13. The plate 210, transducer 220, and object 13 are then raised again to form the nip between the web substrate 232 and the top surface 13S of the object 13. Transwelding of layer 13Y then proceeds.

Repeated transwelding of successive layers are performed to build the object 13. It is noted that at the beginning of building the object 13, the support plate 210 is “empty,” i.e. it is a bare plate with no object material formed on it. In transwelding of the first layer of object 13, the transfer nip is formed between the support plate 210 and the web substrate 232.

In certain embodiments, the backing member 240 may be a cylindrical member as depicted in FIGS. 5A and 5B. In certain embodiments, the cylindrical member may be a roller that has rotary motion as the transwelding occurs, functioning in a manner analogous to that of a “rolling pin” when rolling dough on a board. In certain embodiments, the backing member 240 may be provided with an outer layer (not shown) of material that is compliant, e.g., a rubber or other elastomer. In that manner, more uniform pressure is applied to the material of the layer 13X in the nip during transwelding.

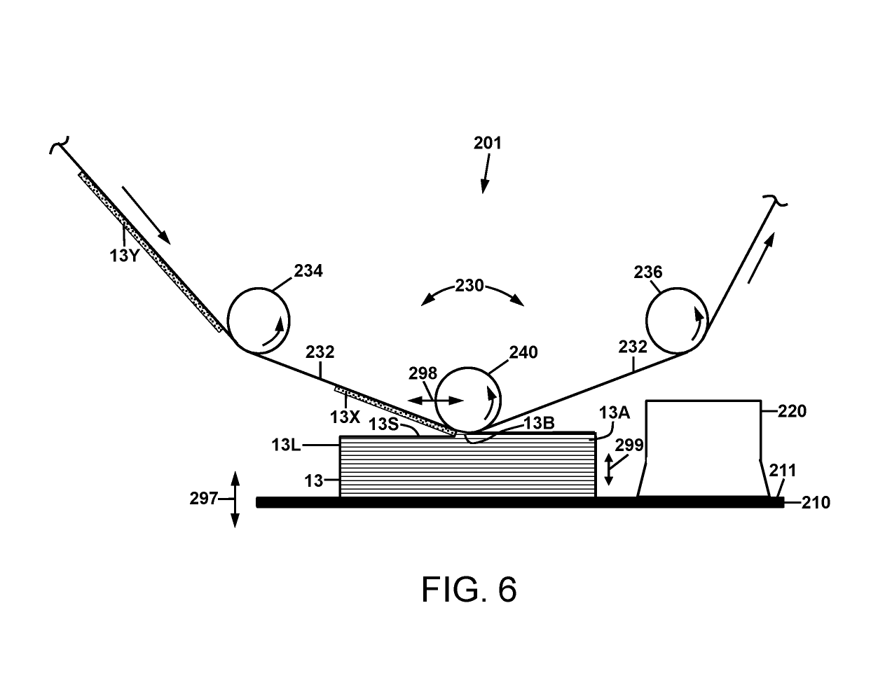

FIG. 6 is a schematic diagram of an alternative embodiment of the transwelding apparatus 200 of FIGS. 5A and 5B. The apparatus 201 of FIG. 6 is depicted midway through the welding of a layer 13X of powder to the object 13 as depicted in FIG. 5B. The apparatus 201 differs from apparatus 200 in that the support plate 210 extends laterally, and the vibratory transducer 220 is coupled to the upper surface 211 of the support plate 210 and imparts ultrasonic energy thereto.

In operating the apparatus 200 and 201 of FIGS. 5A/5B and FIG. 6, the amplitude of vibratory motion can be chosen to optimize the energy transfer for the materials in use. Referring again to FIGS. 5A and 5B, in an exemplary object fabrication that may be performed, the vibratory transducer 220 may be operated at a frequency of between 15 and 40 kHz, and an amplitude of about 20 micrometers (μm). After transwelding of the first layer of the object 13, the object is firmly attached to the support plate 210. Thin layers (about 0.001 inch thick) of ABS, previously deposited on transport web 232 and sintered, may be sequentially transported to the transwelding zone and transwelded to form an object 13.

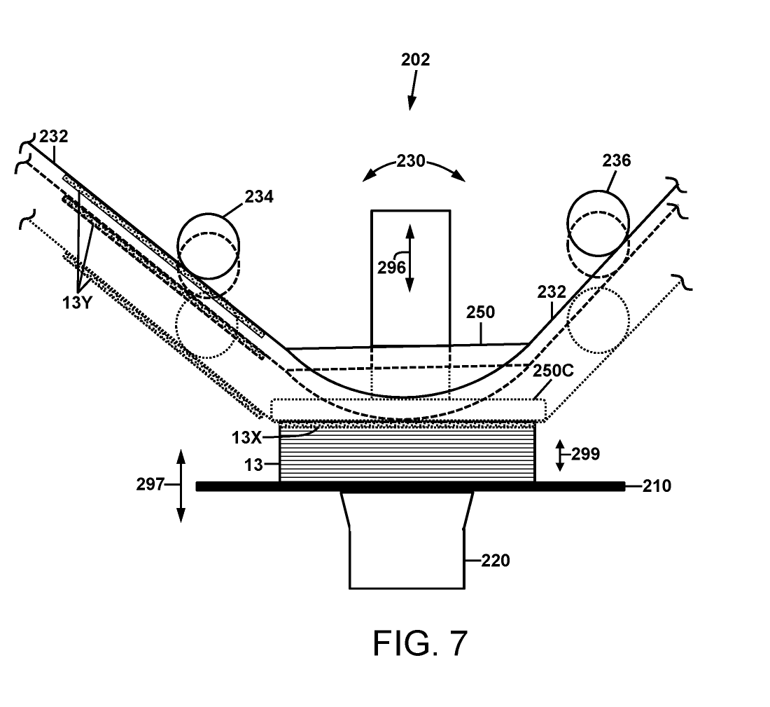

FIG. 7 is a schematic diagram of another alternative embodiment of a transwelding apparatus. The apparatus 202 is similar in some regards to the apparatus 200 of FIGS. 5A and 5B, but differs in that it includes a conformable pressure plate, which enables a stamp and repeat mode of operation. Like apparatus 200 of FIGS. 5A/5B, apparatus 202 is comprised of a support plate 210, a vibratory transducer 220, and a web delivery system 230. Such components function as described for apparatus 200, and thus will not be described in detail here.

In the operation of apparatus 202, the web delivery system indexes the web so that a sintered layer 13X is in position for transwelding to the object 13. A conformable pressure plate 250 is advanced downwardly as indicated by arrow 296 from a home position (solid line) to a first position of contact (coarse dotted line) with the portion of the web 232 carrying the layer 13X, and then into a second position of contact (fine dotted line) with the portion of the web 232 carrying the layer 13X. The second position is a compressive position. The conformable pressure plate 250 is made of an elastomeric material that deforms when forced against the web 232, layer 13X and object 13 to be fabricated. In FIG. 7, the conformable pressure plate 250 is depicted as being sufficiently conformable so as to deform into an approximately rectangular shape 250C that contacts the entire area of the web 232 that is carrying the layer 13X to be transwelded. In that manner, strong uniform pressure is applied to the layer 13X during transwelding. It is noted that in addition to displacing the pressure plate 250 downwardly, the rollers 234 and 236 and web 232 may also be displaced in order to maintain the web 232 under tension. Alternatively, the rollers 234 and 236 may be positioned in other locations so as to maintain continuous tension on the web 232.

Once the conformable pressure plate 250 has been moved into the compressive position against the layer 13X and object 13, the vibratory transducer 220 is actuated and delivers ultrasonic energy into the plate 210, the object 13, and layer 13X, and the entire layer 13X is transwelded to the object 13. The vibratory transducer 220 is then stopped, the conformable pressure plate 250 is retracted to its home position, the web substrate is indexed to place layer 13Y in the transwelding zone, and the conformable pressure plate 250 is again advanced to the compressive position. Transwelding of layer 13Y then occurs. The cycle is repeated as many times as needed to build the object 13 in successive layers.

It is further noted that the apparatus 200, 201, and 202 of FIGS. 5A, 6, and 7 may be used to fabricate objects comprised of more than one material. For example, layers to be transwelded may be comprised of a plurality of materials as described previously for apparatus 1 of FIG. 1 (e.g., layer 10E comprised of primary powder material 10F and support material 10G). The support material may be dissolved by a solvent that does not dissolve the primary powder material, in order to fabricate an object with a complex geometry.

It is, therefore, apparent that there has been provided, in accordance with the present invention, a method and apparatus for fabricating an object. Having thus described the basic concept of the invention, it will be rather apparent to those skilled in the art that the foregoing detailed disclosure is intended to be presented by way of example only, and is not limiting. Various alterations, improvements, and modifications will occur to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims.

What is claimed is:

1. An apparatus for forming a part, the apparatus comprising:
a) a support substrate;
b) a transport web;
c) a transport web delivery system;
d) a powder imaging system configured to deposit a sequence of imaged layers of powder on a sequence of areas of the transport web delivered by the web delivery system;
e) a sintering station configured to sinter the sequence of imaged layers of powder on the transport web to form a sequence of sintered powder layers, the sequence of sintered powder layers comprising a first sintered powder layer, intermediate sintered powder layers, and a last sintered powder layer; and
f) a transfer station comprising a vibratory horn movable relative to the support substrate to form a transfer nip within which the first of the sintered powder layers is fuseable upon the support substrate to form a first fused layer, and each of the intermediate sintered powder layers is fuseable to a preceding fused layer, and the last sintered powder layer is fuseable to a last preceding fused layer, wherein fusing of the sequence of sintered layers form the part.

2. The apparatus of claim 1, further comprising a compliant material joined to a distal end of the vibratory horn.

3. The apparatus of claim 1, further comprising a compliant material interposed between the vibratory horn and the transport web.

4. The apparatus of claim 1, further comprised of a reciprocator configured to move the support substrate synchronously with motion of the transport web.

5. The apparatus of claim 1, wherein the transport web is deliverable by the web delivery system along a delivery axis, and the vibratory horn is comprised of an elongated distal end contactable with the transport web and having a longitudinal axis transverse to the delivery axis of the web.

6. The apparatus of claim 1, wherein the powder imaging system is a xerographic toner powder imaging system.

7. The apparatus of claim 1, wherein the vibratory horn is vibratable at a frequency of between 15 kHz and 40 kHz.

8. A method for forming a part, the method comprising:
a) depositing a first layer of a powder on a transport web substrate;
b) sintering the first layer of powder to form a first sintered layer on the transport web substrate;
c) conveying the first sintered layer to a location proximate to a support substrate;
d) contacting a vibratory horn with the transport web substrate at the location of the first sintered layer on the transport web substrate, and moving the vibratory horn to cause the transport web substrate and first sintered layer to move to a location wherein the first sintered layer is in contact with the support substrate; and
e) oscillating the vibratory horn at a frequency to cause fusing of the first sintered layer into a first fused layer of the part, the first fused layer removably joined to the substrate.

9. The method of claim 8, further comprising depositing a second layer of powder on the transport web substrate; sintering the second layer of powder on the transport web substrate to form a second sintered layer on the transport web substrate; conveying the second sintered layer to the location proximate to the support substrate; contacting the vibratory horn with the transport web substrate at the location of the second sintered layer on the transport web substrate, and moving the vibratory horn to cause the transport web substrate and second sintered layer to move to a location wherein the second sintered layer is in contact with the first fused layer; and oscillating the vibratory horn at a frequency to cause fusing of the second sintered layer into a second fused layer of the part joined to the first fused layer of the part.

10. The method of claim 8, further comprising depositing a sequence of layers of powder on the transport web substrate; sintering the sequence of layers of powder on the transport web substrate to form a sequence of sintered layers on the transport web substrate; for each layer of the sequence of sintered layers, conveying that layer of the sequence of sintered layers to the location proximate to the support substrate; for each layer of the sequence of sintered layers, contacting the vibratory horn with the transport web substrate at the location of that sintered layer on the transport web substrate, and moving the vibratory horn to cause the transport web substrate and that sintered layer to move to a location wherein that sintered layer is in contact with a preceding fused layer; and oscillating the vibratory horn at a frequency to cause fusing of that sintered layer into an additional fused layer of the part joined to the preceding fused layer of the part.

11. The method of claim 8, further comprising moving the transport web substrate and first sintered layer in a direction that is transverse to a longitudinal axis of a distal end of the vibratory horn that is contacted with the transport web substrate.

12. The method of claim 8, further comprising disposing a compliant layer between the vibratory horn and the transport web substrate.

13. The method of claim 8, further comprising moving the support substrate and at least the first fused layer of the part synchronously with motion of the transport web substrate while contacting the vibratory horn with the transport web substrate at the location of one of the sintered layers on the transport web substrate, and moving the vibratory horn to cause the transport web substrate and one of the sintered layer to move to a location wherein the one of the sintered layers is in contact with the support substrate or a preceding fused layer, and oscillating the vibratory horn at a frequency to cause fusing of the one of the sintered layers into an additional fused layer of the part.

14. The method of claim 8, wherein the sintering is performed by at least one of heating the first layer of the powder on the transport web substrate or exposing the first layer of the powder on the transport web substrate to a solvent.

15. The method of claim 8, further comprising generating the first imaged layer of powder using a xerographic toner powder generation process prior to depositing the first layer of the powder on the transport web substrate.

16. The method of claim 8, wherein the vibratory horn is oscillated at a frequency of between 15 kHz and 40 kHz.

17. An apparatus for forming a part, the apparatus comprising:
a) a support plate;
b) a transport web;
c) a transport web delivery system;
d) a powder imaging system configured to deposit a sequence of imaged layers of powder on a sequence of areas of the transport web delivered by the web delivery system;
e) a sintering station configured to sinter the sequence of imaged layers of powder on the transport web to form a sequence of sintered powder layers, the sequence of sintered powder layers comprising a first sintered powder layer, intermediate sintered powder layers, and a last sintered powder layer; and
f) a transfer station comprising a backing member and vibratory transducer coupled to the support plate, wherein:
the vibratory transducer and support plate are movable toward the transport web and backing member to form a first layer transfer nip within which the first of the sintered powder layers is fuseable upon the support plate to form a first fused layer, and
the vibratory transducer, support plate, and first and subsequent fused layers are movable toward the transport web to form an intermediate transfer nip within which each of the remaining intermediate sintered powder layers is fuseable to a preceding fused layer, and
the vibratory transducer, support plate, and first and intermediate fused layers are movable toward the transport web to form a last transfer nip within which the last sintered powder layer is fuseable to a last preceding fused layer, wherein fusing of the sequence of sintered layers form the part.

18. The apparatus of claim 17, wherein the transfer nips are formed between the transport web and a part receiving surface of the support plate, and the vibratory transducer is coupled to a vibratory surface of the support plate that is opposed to the part receiving surface.

19. The apparatus of claim 17, wherein the transfer nips are formed between the transport web and a part receiving side of the support plate, and the vibratory transducer is coupled to the part receiving side of the support plate.

20. The apparatus of claim 17, wherein the transfer nips are formed between the transport web and a part receiving surface of the support plate, and the wherein the backing member is movable laterally along the transfer web to cause the transfer nip to move laterally relative to the part.

21. The apparatus of claim 20, wherein the backing member is a cylinder having an axis of rotation parallel to a plane defined by the support plate.

22. The apparatus of claim 21, wherein the cylinder is rotatable around its axis of rotation while translating laterally along the transfer web.

23. The apparatus of claim 21, wherein the cylinder comprised of a compliant outer layer.

24. The apparatus of claim 17, wherein the backing member is comprised of a conformable pressure plate contactable with an entire area of the web substrate opposed to an upper surface of the part when receiving an intermediate or last sintered layer of the part.

25. The apparatus of claim 17, wherein the vibratory transducer is vibratable at a frequency of between 15 kHz and 40 kHz.

26. A method for forming a part, the method comprising:
a) depositing a first layer of a powder on a transport web substrate;
b) sintering the first layer of powder to form a first sintered layer on the transport web substrate;
c) conveying the first sintered layer to a location proximate to a support plate;
d) coupling a vibratory transducer to the support plate and moving the vibratory transducer and support plate toward the transport web substrate to form a first layer transfer nip at an edge of the first sintered layer and between a backing member and the support plate;
e) oscillating the vibratory transducer at a frequency to cause fusing of the first sintered layer into a portion of a first fused layer of the part within the nip; and
f) moving the backing member laterally along a plane parallel to the plane defined by the support plate to cause the nip to move laterally along the first sintered layer and cause the first sintered layer to fuse, forming the first fused layer removably joined to the substrate.

27. The method of claim 26, further comprising depositing a second layer of powder on the transport web substrate; sintering the second layer of powder on the transport web substrate to form a second sintered layer on the transport web substrate; conveying the second sintered layer to a location proximate to the first fused layer; moving the vibratory transducer, support plate, and first fused layer toward the transport web substrate to form a second layer transfer nip at an edge of the second sintered layer and between the backing member and the first fused layer; oscillating the vibratory transducer at a frequency to cause fusing of the second sintered layer into a portion of a second fused layer of the part within the nip; and moving the backing member laterally along the plane parallel to the plane defined by the support plate to cause the first layer transfer nip to move laterally along the second sintered layer and cause the second sintered layer to fuse, forming the second fused layer joined to the first fused layer.

28. The method of claim 27, further comprising depositing a sequence of layers of powder on the transport web substrate; sintering the sequence of layers of powder on the transport web substrate to form a sequence of sintered layers on the transport web substrate; and for each layer of the sequence of sintered layers, conveying that sintered layer to a location proximate to the preceding fused layer; moving the vibratory transducer, support plate, and fused layers toward the transport web substrate to form an additional layer transfer nip at an edge of that sintered layer and between the backing member and the preceding fused layer; oscillating the vibratory transducer at a frequency to cause fusing of that sintered layer into a portion of an additional fused layer of the part within the nip; and moving the backing member laterally along the plane parallel to the plane defined by the support plate to cause that layer transfer nip to move laterally along that sintered layer and cause that sintered layer to fuse, forming the additional fused layer joined to the preceding fused layer of the part.

29. The method of claim 26, wherein the vibratory transducer is oscillated at a frequency of between 15 kHz and 40 kHz.

30. A method for forming a part, the method comprising:
a) depositing a first layer of a powder on a transport web substrate;
b) sintering the first layer of powder to form a first sintered layer on the transport web substrate;
c) coupling a vibratory transducer to a support plate;
d) conveying the first sintered layer to a location between the support plate and a pressure plate comprising a conformable compression member;
e) moving the pressure plate toward the transport web substrate to cause the entire first sintered layer to contact the support plate and cause the conformable compression member to contact an entire area of the web substrate in contact with the first sintered layer; and
f) oscillating the vibratory transducer at a frequency to cause the first sintered layer to fuse into a first fused layer removably joined to the substrate.

31. The method of claim 30, further comprising depositing a second layer of powder on the transport web substrate; sintering the second layer of powder on the transport web substrate to form a second sintered layer on the transport web substrate; conveying the second sintered layer to a location between the first fused layer and the pressure plate; moving the pressure plate toward the transport web substrate to cause the entire second sintered layer to contact the first fused layer and cause the conformable compression member to contact an entire area of the web substrate in contact with the second sintered layer; and oscillating the vibratory transducer at a frequency to cause the second sintered layer to fuse into a second fused layer joined to the first fused layer.

32. The method of claim 31, further comprising depositing a sequence of layers of powder on the transport web substrate; sintering the sequence of layers of powder on the transport web substrate to form a sequence of sintered layers on the transport web substrate; and for each layer of the sequence of sintered layers, conveying that sintered layer to a location between the preceding fused layer and the pressure plate; moving the pressure plate toward the transport web substrate to cause that entire sintered layer to contact the preceding fused layer and cause the conformable compression member to contact an entire area of the web substrate in contact with that sintered layer; and oscillating the vibratory transducer at a frequency to cause that sintered layer to fuse into an additional fused layer joined to the preceding fused layer.
